(19) United States
(12) Patent Application Publication
(10) Pub. No.: US 2024/0160341 A1
(43) Pub. Date: May 16, 2024

(54) VIDEO PROCESSING METHODS, DEVICE, STORAGE MEDIUM, AND PROGRAM PRODUCT

(71) Applicant: Beijing Zitiao Network Technology Co., Ltd., Beijing (CN)

(72) Inventors: Zitong He, Beijing (CN); Yinan Jia, Beijing (CN)

(21) Appl. No.: 18/392,374

(22) Filed: Dec. 21, 2023

Related U.S. Application Data
(63) Continuation of application No. PCT/CN2022/116918, filed on Sep. 2, 2022.

(30) Foreign Application Priority Data
Sep. 2, 2021 (CN) 202111026925.X

(51) Int. Cl. G06F 3/04845; G06F 3/0481; G11B 27/036; H04N 21/4788

(52) U.S. Cl. CPC G06F 3/04845; G06F 3/0481; G11B 27/036; H04N 21/4788

(57) ABSTRACT

Embodiments of the present disclosure provide video processing methods and devices, an electronic device, a computer-readable storage medium, a computer program product and a computer program. In response to a comment data input instruction for a target video, a terminal of a comment sender acquires a comment material, wherein the comment material includes an image; and in response to a request instruction for sending comment data, if the comment data has been confirmed, the comment data is presented in a playing process of the target video, wherein the comment data comprises the comment material.

### CROSS-REFERENCE TO RELATED APPLICATIONS

The present disclosure is a U.S. National Stage Application of PCT Application Serial No. PCT/CN2022/116918, filed Sep. 2, 2022, which claims priority to Chinese Patent Application No. 202111026925.X, filed with the China National Intellectual Property Administration on Sep. 2, 2021 and entitled “VIDEO PROCESSING METHODS, DEVICE, STORAGE MEDIUM, AND PROGRAM PRODUCT”, the disclosure of which are incorporated herein by reference in their entireties.

### FIELD

Embodiments of the present disclosure relate to the technical field of computers and network communications, and in particular, to video processing methods and devices, an electronic device, a computer-readable storage medium, a computer program product, and a computer program.

### BACKGROUND

Comments refer to comment contents sent by users when the users watch a video via an Internet, and are usually displayed on video pictures in a scrolling manner, a hovering manner, and other manners. Through the comments, a user can read comments from other users in real time, thereby increasing interactions between the users and increasing the viewing pleasure.

In the related technology, the comment interaction manner is single, and a comment interaction space is limited, which cannot meet the more diverse comment interaction needs of the users and affects the user experience.

### SUMMARY

Embodiments of the present disclosure provide video processing methods and devices, an electronic device, a computer-readable storage medium, a computer program product, and a computer program.

In a first aspect, the embodiments of the present disclosure provide a video processing method, applied to a terminal of a comment sender. The method includes:
in response to a comment data input instruction for a target video, acquiring a comment material, wherein the comment material includes an image; and
in response to a request instruction for sending comment data, if the comment data has been confirmed, presenting the comment data in a playing process of the target video, wherein the comment data comprises the comment material.

In a second aspect, the embodiments of the present disclosure provide a video processing method, applied to a terminal of a target video poster. The method includes:
receiving comment data sent by a terminal of a comment sender, wherein the comment data comprises a comment material and attribute information thereof, and the comment material includes an image; and
in response to a confirming instruction for the comment data, adding the comment data into the target video.

In a third aspect, the embodiments of the present disclosure provide a video processing apparatus, applied to a terminal of a comment sender. The apparatus includes:
an inputting unit, configured to: in response to a comment data input instruction for a target video, acquire a comment material, wherein the comment material includes an image; and
a sending unit, configured to: in response to a request instruction for sending comment data, if the comment data has been confirmed, present the comment data in a playing process of the target video, wherein the comment data comprises the comment material.

In a fourth aspect, the embodiments of the present disclosure provide a video processing apparatus, applied to a terminal of a target video poster. The apparatus includes:
a receiving unit, configured to: receive comment data sent by a terminal of a comment sender, wherein the comment data comprises a comment material and attribute information thereof, and the comment material includes an image; and
a sending unit, configured to: in response to a confirming instruction for the comment data, add the comment data into the target video.

In a fifth aspect, the embodiments of the present disclosure provide an electronic device, including: at least one processor, a memory, and a display unit,
wherein the memory stores computer-executable instructions; and
the at least one processor executes the computer-executable instructions stored in the memory to cause the at least one processor to perform the video processing method designed in the first aspect and various possible video processing methods in the first aspect, or the video processing method designed in the second aspect and various possible video processing methods in the second aspect.

In a sixth aspect, the embodiments of the present disclosure provide a computer-readable storage medium, wherein the computer-readable storage medium stores computer-executable instructions; and a processor, when executing the computer-executable instructions, implements the video processing method designed in the first aspect and various possible video processing methods in the first aspect, or the video processing method designed in the second aspect and various possible video processing methods in the second aspect.

In a seventh aspect, the embodiments of the present disclosure provide a computer program product, including computer-executable instructions, wherein a processor, when executing the computer-executable instructions, implements the video processing method designed in the first aspect and various possible video processing methods in the first aspect, or the video processing method designed in the second aspect and various possible video processing methods in the second aspect.

In an eighth aspect, the embodiments of the present disclosure provide a computer program, wherein the computer program, when executed by a processor, implements the video processing method designed in the first aspect and various possible video processing methods in the first aspect, or the video processing method designed in the second aspect and various possible video processing methods in the second aspect.

### BRIEF DESCRIPTION OF THE DRAWINGS

In order to describe the technical solutions in the embodiments of the present disclosure or in the related technology more clearly, the following briefly introduces the accompanying drawings for describing the embodiments or the related technology. Apparently, the accompanying drawings in the following description show some embodiments of the present disclosure, and a person of ordinary skill in the art may still derive other drawings from the accompanying drawings without creative efforts.

FIG. 1 is a schematic diagram of an application scenario of a video processing method according to an embodiment of the present disclosure;

FIG. 2 is a flowchart of a video processing method according to an embodiment of the present disclosure;

FIG. 3 is an interface example diagram of a terminal of a comment sender according to an embodiment of the present disclosure;

FIG. 4a is a flowchart of a video processing method according to another embodiment of the present disclosure;

FIG. 4b is an interface example diagram of a terminal of a comment sender according to another embodiment of the present disclosure;

FIG. 5 is a flowchart of a video processing method according to another embodiment of the present disclosure;

FIG. 6 is a flowchart of a video processing method according to another embodiment of the present disclosure;

FIG. 7a is an interface example diagram of a terminal of a target video sender according to an embodiment of the present disclosure;

FIG. 7b is an interface example diagram of a terminal of a target video sender according to another embodiment of the present disclosure;

FIG. 8 is a structural block diagram of a video processing apparatus according to an embodiment of the present disclosure;

FIG. 9 is a structural block diagram of a video processing apparatus according to another embodiment of the present disclosure; and

FIG. 10 is a schematic structural diagram of hardware of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

Comments refer to comment contents, for example bullet screens, sent by users when the users watch a video via an Internet, and are usually displayed on video pictures in a scrolling manner, a hovering manner, and other manners. Relevant comments only support text and expressions (such as emoji), but cannot support static pictures, dynamic pictures, video clips, and the like. The ability of expression of the users through comments is limited, which affects the user experience. In addition, the relevant comment interaction manner is single, and a comment interaction space is limited, which cannot meet the more diverse comment interaction needs of the users.

In order to solve the above technical problems, in the embodiments of the present disclosure, a user can send comments in the form of static pictures, dynamic pictures, video clips, etc., enriching the expression ability of the user and stimulating the creativity of the user. However, considering that the comments in the form of static pictures, dynamic pictures, videos, and the like have larger sizes than texts and expressions, they may cover a currently played video and affect another user from watching the video. Therefore, in the present disclosure, it is hoped that after the user sends the comments in the form of static pictures, dynamic pictures, and videos, the user can confirm these comments and decide whether to allow these comments to exist as a part of the video, thereby enriching the comment interaction manner, avoiding presentation of unexpected comments in a video playing process, ensuring the quality of the video, and improving the user experience.

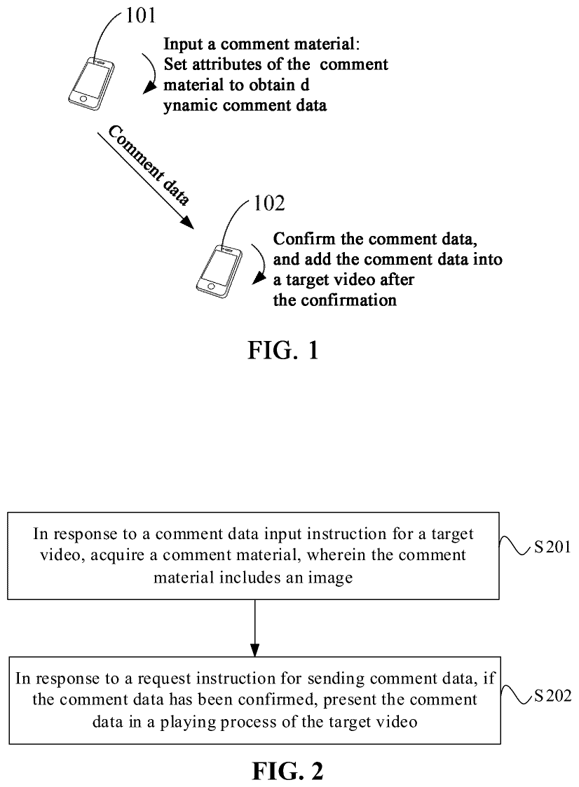

The video processing method provided in the embodiments of the present disclosure is applicable to an application scenario as shown in FIG. 1, which includes a terminal 101 of a comment sender and a terminal 102 of a target video poster. The terminal 101 of the comment sender and the terminal 102 of the target video poster can be in communication connection to each other. Optionally, the terminal 101 of the comment sender and the terminal 102 of the target video poster are connected through a server. The terminal 101 of the comment sender is configured to: in response to a comment data input instruction for a target video, acquire a comment material, wherein the comment material includes an image; and in response to a request instruction for sending comment data, send the comment data of the comment material to the terminal 102 of the target video poster, so that the terminal 102 of the target video poster confirms the comment data and adds the comment data into the target video after the comment data has been confirmed.

Referring to FIG. 2, FIG. 2 is a flowchart of a video processing method according to an embodiment of the present disclosure. The method of this embodiment can be applied to a terminal of a comment sender. The video processing method includes:

S201. In response to a comment data input instruction for a target video, a comment material is acquired, wherein the comment material includes an image. The image may include at least one of a static picture, a dynamic picture, or a video clip.

In this embodiment, in a process that the terminal plays the target video, the comment sender can send a comment to the target video on the terminal. Typically, some text type comments or comments including emoji (drawing text) expression characters can be sent. In this embodiment, the comment sender can send comments including static pictures, dynamic pictures, or video clips. In this embodiment, the specific format of the static picture, the dynamic picture, or the video clip is not limited.

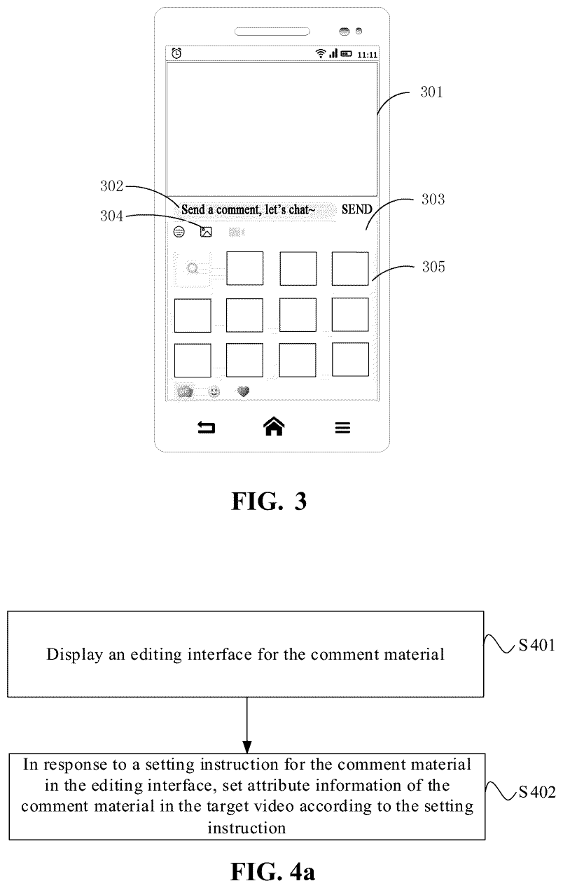

Specifically, as shown in FIG. 3, on the terminal of the comment sender, the playing interface 301 of the target video can be configured with an entry 302 for writing a comment. The comment sender can click on the entry for writing a comment and wake up a comment inputting panel 303. The comment inputting panel 303 can be configured with a Tab 304 of at least one type of comment material, such as a Tab of static picture, dynamic picture, or video clip. The comment sender clicks on the Tab of one type of comment material to enter a comment material selection and adding page 305. For example, when clicking on the Tab of static picture, the comment sender can enter a static picture selection and adding page. This page displays recommended static pictures and can also have an entry to a local album, so that the comment sender can enter the local album to select a static picture. When clicking on the Tab of video clip, the comment sender can enter a video clip selection and adding page. This page displays candidate video clips and can also have an entry to the local album, so that the comment sender can enter the local album to select a video clip.

Optionally, the comment sender can also set attribute information of the comment material, including but not limited to at least one of a style, position, time information, and motion trajectory of the comment material.

S202. In response to a request instruction for sending comment data, if the comment data has been confirmed, the comment data is presented in a playing process of the target video, wherein the comment data comprises the comment material.

In this embodiment, the comment sender sends the request instruction for sending the comment data after inputting the comment material, so that detection personnel can confirm the comment data. The detection personnel can be management personnel of a video playing platform, or a target video poster, or another personnel. If the comment data has been confirmed, the comment data is presented in the playing process of the target video.

Optionally, in response to the request instruction for sending the comment data, the comment data of the comment material can be sent to a terminal of a target video poster, so that the target video poster confirms the comment data. Optionally, the comment data can include but not limited to the comment material, the attribute information of the comment material, information of the comment sender, sending time, and the like. The terminal of the target video poster presents the comment data after receiving the comment data of the comment material, so that the target video poster confirms the comment data. After the target video poster confirms the comment data, the comment data is added into the target video, that is, the comment data is presented in the playing process of the target video.

Confirming the comment data by the video poster can improve the quality of the comments in the form of static picture, dynamic picture, video clip, and the like and avoid inappropriate comments from covering the target video and affecting a user from watching the target video, which is more in line with the expectation of the video poster. Moreover, a video watcher sends a comment in the form of static picture, dynamic picture, video clip, and the like, a video poster participates in confirmation of the comment, and a comment sender participates in video creation, so that a good creation atmosphere has been achieved between the video poster and a user, which enriches the comment interaction manner and improves the user experience.

Optionally, the comment data including the comment material is sent to the terminal of the target video poster. Specifically, the comment data with the comment material can be uploaded to the server, and the server sends the comment data with the comment material to the terminal of the target video poster.

Optionally, the comment data with the comment material is added into the target video. Specifically, the comment data with the comment material can be uploaded to the server and added into a comment list of the target video, so that the comment material is displayed in a masked form in a video picture of the target video on the terminals of all users watching the target video and turning on comment displaying, so that these users can watch this comment material. Optionally, since the comment data with the comment material is sent to the terminal of the target video poster through the server, the comment data with the comment material can be cached by the server. After the confirmation succeeds, the terminal of the target video poster can send, to the server, an instruction for agreeing to add a subtitle, and the server will add the comment data with the comment material into a comment list of the target video according to the instruction. Optionally, the comment data with the comment material can also be uploaded to the server by the terminal of the comment sender and is then added into a comment list of the target video.

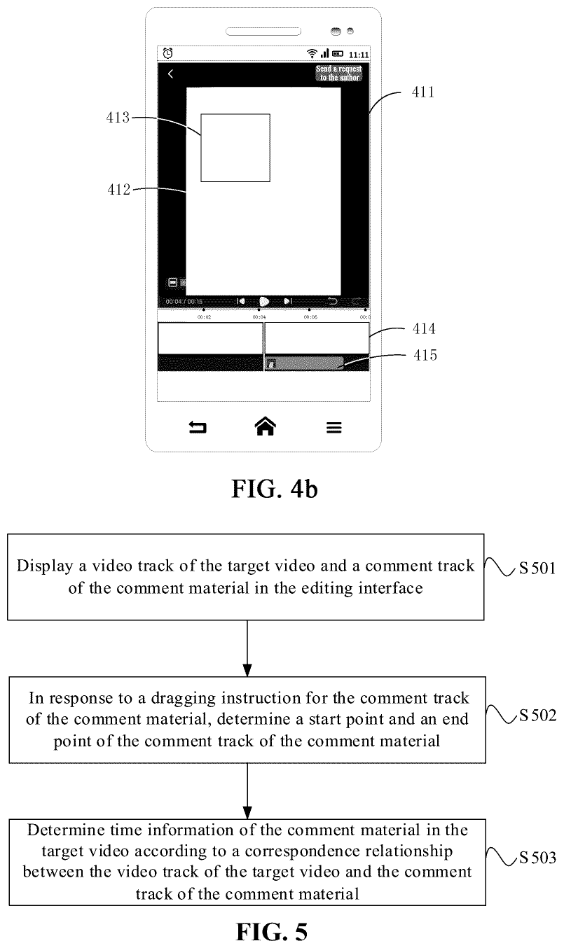

Based on any of the above embodiments, as shown in FIG. 4a, after the comment material is input to the terminal of the comment sender, the method further includes:

S401. An editing interface for the comment material is displayed.

S402. In response to a setting instruction for the comment material in the editing interface, the attribute information of the comment material is set in the target video according to the setting instruction.

In this embodiment, after the comment material is input, the terminal of the comment sender can display the editing interface of the comment material. In the editing interface of the comment material, the comment sender can edit any attribute information of the comment material, including but not limited to at least one of the style, position, time information, and motion trajectory of the comment material in the target video. The style includes but is not limited to a size, an angle, definition, contrast, transparency, and the like. A user can input the setting instruction for comment material in the editing interface, for example, a setting instruction for the style of the comment material, a setting instruction for the position of the comment material, a setting instruction for the time information of the comment material, and a setting instruction for the motion trajectory of the comment material, so that the terminal of the comment sender sets the attribute information of comment material in the target video according to the setting instruction for the comment material to obtain the comment data. Further, the comment sender can issue the request instruction for sending comment data. The request instruction for sending comment data can be clicking on a confirmation button for the attribute information of the comment material. The terminal of the comment sender can send, in response to the request instruction for sending comment data, the comment data including the comment material to the terminal of the target video poster.

Optionally, in S402, at least one of a style, position, time information, and motion trajectory of the comment material is set in the target video according to the setting instruction, which includes:
a video picture of the target video at a target moment is displayed in the editing interface, and a canvas is added on the video picture, wherein the canvas is used for displaying the comment material; and
in response to a setting instruction for a style and/or position of the canvas, the style and/or position of the comment material displayed on the canvas is determined.

In this embodiment, during the setting of the attribute information, the editing interface can display a video picture of the target video, and playing, pause, fast forward, fast backward, and the like of the target video can be controlled. Optionally, during entering of the editing interface, the target video can be controlled to be paused at the target moment. The target moment can be a moment of the target video when the comment material is input or a moment of the target video when the user clicks on the entry for writing a comment. Further, as shown in FIG. 4b, a canvas 413 is added on a video picture 412 of the editing interface 411 to display the comment material. The canvas 413 can be adjusted in size, angle, and position, so that a size, angle, and position of the comment material displayed on the canvas can be adjusted. An adjustment manner can be clicking, dragging, and other operations performed on the canvas 413, which will not be described in detail here. After a setting instruction of a user on the style and/or position of the canvas 413 is received, the style and/or position of the comment material displayed on the canvas 413 can be determined. It should be noted that if the style and/or position of the comment material changes, a mapping relationship between the style and/or position and a video timeline needs to be set. Of course, the style and/or position of the canvas in the video picture frame by frame. This will not be described in detail here.

In addition, a time information setting option or a time information input box can be displayed on the editing interface, so as to set the time information of the comment material. For example, specific presentation time of a comment in the video playing process can be selected in the time information setting option, or specific presentation time of a comment in the video playing process can be input to the time information input box. A position information setting option or a position information input box can also be displayed on the comment editing interface, so as to set the position information of the comment material. For example, the information setting option includes a top of the video picture, a bottom of the video picture, and the like. This facilitates a user to quickly set comment attribute information and meets diverse comment needs of the user.

By setting, on the editing interface, at least one piece of attribute information of the style, position, time information, and motion trajectory of the comment material in the target video, this embodiment can present the comment material in a form expected by the user, meet a personalized need of the user, improve the willingness of the user to send a comment, and encourage the user to participate in video creation.

Optionally, as shown in FIG. 5, in S402, time information of the comment material is set in the target video according to the setting instruction, which includes:

S501. A video track of the target video and a comment track of the comment material are displayed in the editing interface.

S502. In response to a dragging instruction for the comment track of the comment material, a start point and an end point of the comment track of the comment material are determined.

S503. The time information of the comment material in the target video is determined according to a correspondence relationship between the video track of the target video and the comment track of the comment material.

In this embodiment, as shown in FIG. 4b, a video track 414 of the target video can be displayed in the editing interface 411, while a comment track 415 of the comment material can be displayed in a contrast manner. The comment sender can drag the comment track 415 of the comment material, especially the start point and the end point of the comment track 415 of the comment material, so that a start point and an end point of displaying of the comment material in the target video can be determined. If the comment material is a static picture, a plurality of copies of the static picture can be made on the comment track 415 of the comment material. For a dynamic picture or a video clip, each frame can be displayed in the comment track 415 of the comment material. A playing speed of the dynamic picture or video clip can also be set in the comment track 415 of the comment material.

Further, after the setting of the start point and the end point of the comment track of the comment material is completed, the time information of the comment material in the target video can be determined according to the correspondence relationship between the video track of the target video and the comment track of the comment material.

Optionally, according to the correspondence relationship between the video track of the target video and the comment track of the comment material, a mapping relationship between each frame of picture of the comment material and a timeline of the target video can be established, or a mapping relationship between each frame of picture of the comment material and a video frame of the target video can be established, or a mapping relationship between a timeline of the comment material and a timeline of the target video can be established. By establishing the mapping relationship described above, when the target video starts to be played at a certain moment, or during fast forward, backward, or playing at a multiplied speed, the comment material can also be displayed correspondingly and kept pace with the target video.

Optionally, based on any of the above embodiments, the motion trajectory of the comment material needs to be set for such a case that the position of the comment material changes. In response to a setting instruction of the comment sender on a motion trajectory of a canvas, a mapping relationship between a coordinate of the canvas in the video picture and video time can be established, which means that the motion trajectory of the comment material is set. Specifically, the motion trajectory of the comment material is set in the target video according to the setting instruction, which includes:
a video picture of the target video at a target moment is displayed in the editing interface, and a canvas is added on the video picture, wherein the canvas is used for displaying the comment material; a video track or a progress bar of the target video is displayed in the editing interface; and
in response to a setting instruction for a motion trajectory on the canvas, canvas positions corresponding to different time points in the video track or the progress bar are determined to determine the motion trajectory of the comment material.

In this embodiment, when the comment material needs to move along a certain motion trajectory in the video picture, the motion trajectory of the canvas that displays the comment material can be set, and the canvas positions corresponding to different times in the video track or progress bar can be set. For example, for a linear motion, a coordinate of a canvas position at start time of the linear motion and a coordinate of a canvas position at end time can be set on the basis of the video track or progress bar, thus determining coordinates of the canvas positions corresponding to different time points of the linear motion. For other motion trajectories, coordinates of canvas positions of a plurality of key points in the motion trajectory can be set on the basis of the video track or progress bar. Of course, in this embodiment, the coordinates of the canvas positions can also be set time by time, or the motion trajectory of the canvas can be drawn first, and time information corresponding to each point in the motion trajectory is then set, so that the comment material is finally caused to move according to the set motion trajectory.

Based on any of the above embodiments, after the confirmation by the target video poster succeeds, the terminal of the target video poster can send notification information that indicates a confirmation success to the terminal of the comment sender, and the notification information is displayed on the terminal of the comment sender, so that the comment sender can know a confirmation result, which increases interaction between the comment sender and the target video poster.

In addition, after the confirmation succeeds, the terminal of the comment sender can display the comment material in a masked manner in the video picture of the target video according to the comment data, so that the comment sender can watch, in the target video, a real effect of the comment data added by the comment sender.

In another optional embodiment, if the confirmation by the target video poster fails, the terminal of the target video poster can send notification information that indicates a confirmation failure to the terminal of the comment sender, and the notification information is displayed on the terminal of the comment sender.

In another optional embodiment, if the target video poster intends to modify the comment material and/or the attribute information of the comment material, the terminal of the target video poster can send a modification request for the comment material and/or the attribute information of the comment material to the terminal of the comment sender, so that the terminal of the comment sender can perform the process in the above embodiment again after the modification according to the modification request.

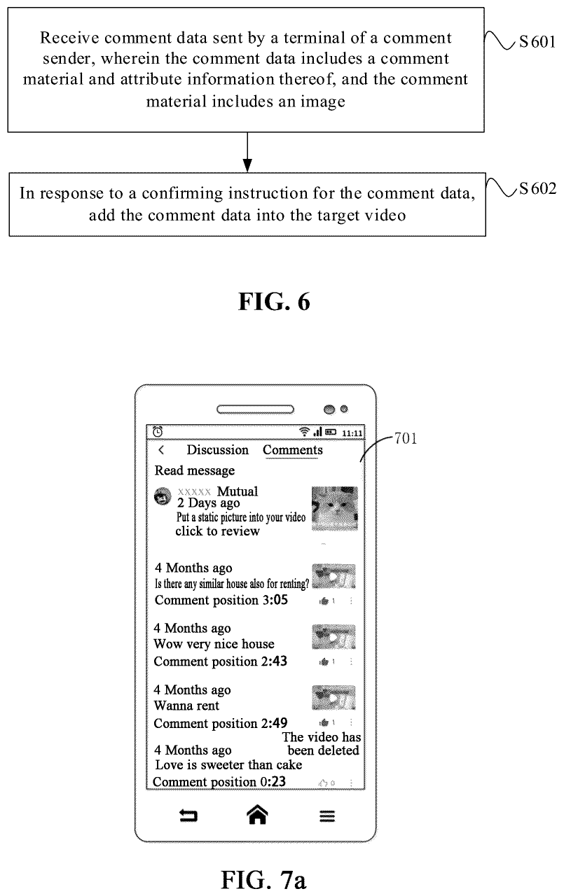

Referring to FIG. 6, FIG. 6 is a flowchart of a video processing method according to an embodiment of the present disclosure. The method of this embodiment can be applied to a terminal of a target video poster. The video processing method includes:

S601. Comment data sent by a terminal of a comment sender is received, wherein the comment data comprises a comment material and attribute information thereof, and the comment material includes an image.

S602. In response to a confirming instruction for the comment data, the comment data is added into the target video.

Optionally, the comment data also includes attribute information of the comment material, and the attribute information includes at least one of a style, position, time information, and motion trajectory of the comment material. The method further includes:
in response to a comment preview instruction, a preview interface is displayed, and the comment material is displayed in the target video in the preview interface according to the comment data. Through the preview interface, the target video poster can more clearly preview an effect of adding the comment data, so as to determine whether to make confirmation succeed and determine whether to ultimately add the comment data into the target video.

This embodiment is a method embodiment on the terminal side of the target video poster in the above embodiment, wherein processes of receiving the comment data sent by the terminal of the comment sender and adding the comment data into the target video can refer to those in the above embodiment, and will not be described in detail here.

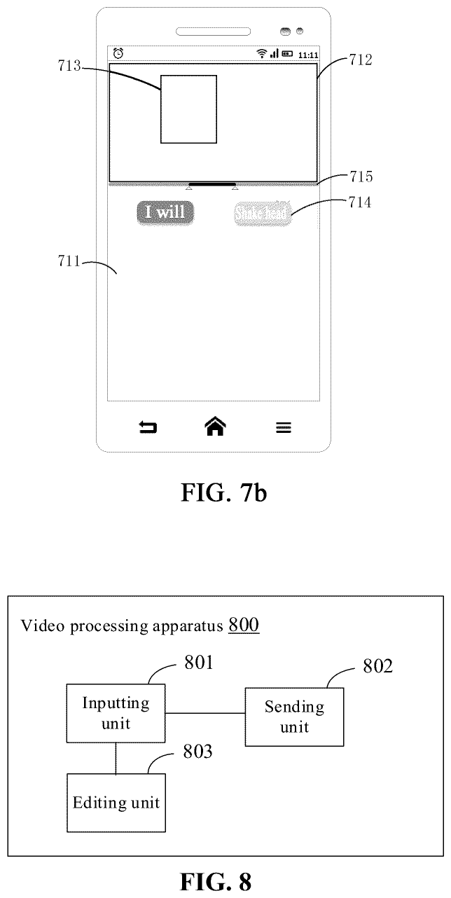

In this embodiment, after the terminal of the target video poster receives the comment data sent by the terminal of the comment sender, as shown in FIG. 7a, the comment data can be presented in a comment request list 701 of the terminal of the target video poster.

Optionally, if comment data sent by terminals of a plurality of different comment senders has been received, the comment data is screened and/or sequenced and presented according to a predetermined policy. This facilitates the video poster to efficiently confirm the comment data and ensures the experience of the target video poster. The comment data can be screened and/or sequenced according to target information of the comment sender. The target information can include: interaction (for example, like) information with the target video poster and authentication information (for example, authentication information provided by a video platform where the target video is posted) of the comment sender. If a comment sender and the target video poster conduct more interactions, the comment data has a higher ranking in the comment request list, or the comment data of a comment sender with a number of times of interaction greater than a preset number of times is selected and displayed in the comment request list. Thus, this facilitates the video poster to first process comment data requests of interest, which is in line with an expectation of the video poster, improves the processing efficiency of the comment data, and ensures the experience of the target video poster.

Further, the target video poster can click on any comment request in the comment request list to preview a comment. In response to the comment preview instruction, the preview interface can be displayed on the terminal of the target video poster. The preview interface can be as shown in FIG. 7b. In the preview interface 711, a comment material 713 is displayed in a target video 712 according to the comment data, that is, the target video poster confirms which style, position, time information, and motion trajectory where the comment material is specifically displayed. The target video poster can select yes or no, which can be achieved by a button 714 in the preview interface 711.

Optionally, when the comment material is displayed in the target video in the preview interface according to the comment data, time information of the comment material can also be identified in a progress bar of the target video. For example, as shown in FIG. 7b, time at which the comment material appears is identified in a progress bar 715 of the target video by an identifier or a symbol in a specific color, so that it is convenient for the target video poster to quickly locate the time at which the comment material appears.

Further, based on the above embodiment, in response to the confirming instruction for the comment data, notification information that indicates a confirmation success is sent to the terminal of the comment sender. Or, in response to a confirmation failure instruction, notification information that indicates a confirmation failure is sent to the terminal of the comment sender, so as to notify the comment sender of a confirmation result.

Optionally, the video poster can set an automatic confirming function for the comment data of the target video during or after the posting of the target video. If the video poster turns on the automatic confirming function for the comment data, the comment data can be added into the target video according to an association degree between the comment material and the target video and/or based on the target information of the comment sender. Thus, time of confirmation by the target video poster can be saved; the need of the video poster is more comprehensively met; and the degree of automation of comment inspection is increased.

For example, if both the target video and the comment material are contents of the same theme, the association degree is high, and the comment data can be directly added into the target video. Or, if there is a certain association relationship (such as a co-creation relationship, for example, the comment sender and the target video poster had co-created a video before) between the comment sender and the target video poster, or if there are many interactions between the comment sender and the target video poster, the comment data can be added into the target video. Thus, the matching degree between the comment data and the target video can be ensured, and a co-creation effect between the comment sender and the video poster is enhanced.

Optionally, if the target video poster intends to modify the comment material and/or the attribute information of the comment material, the terminal of the target video poster can send a modification request for the comment material and/or the attribute information of the comment material to the terminal of the comment sender, so that the terminal of the comment sender can perform the process in the above embodiment again after the modification. Or, optionally, the target video poster can also perform secondary creation on the comment material, that is, the target video poster can modify the comment data based on the comment data. The terminal of the target video poster modifies the attribute information of the comment material in the comment data in response to a comment modification instruction. In addition, a modification result can also be sent to the terminal of the comment sender, which achieves a good creation atmosphere between the video poster and a user and improves the user experience.

Based on any of the above embodiments, when any user watches the target video, all user terminals with the comment function turned on can display the comment material added into the target video. Optionally, the user can also select to only display text type comments or only display static picture, dynamic picture, and video clip type comments. Terminals of users that select to display the static picture, dynamic picture, and video clip type comments will display the comment material added into the target video.

Optionally, the user can click on the comment material to wake up a control panel of comments. The control panel displays a like button, a report button, and the like, and the user can perform a like or report operation.

Optionally, the terminal of the user can also display a comment list which displays comment information of the comment material, for example, a picture of the comment material, information of the comment sender, and the like. In response to an instruction of the user on comments, the target video can be controlled to jump to a time point when the comment material starts to be played.

Corresponding to the video processing method of the terminal side of the comment sender in the above embodiment, FIG. 8 is a structural block diagram of a video processing apparatus according to an embodiment of the present disclosure. For ease of explanation, only parts related to the embodiments of the present disclosure are shown. Referring to FIG. 8, the video processing apparatus 800 includes an inputting unit 801 and a sending unit 802.

The inputting unit 801 is configured to: in response to a comment data input instruction for a target video, acquire a comment material, wherein the comment material includes an image; and
the sending unit 802 is configured to: in response to a request instruction for sending comment data, if the comment data has been confirmed, present the comment data in a playing process of the target video, wherein the comment data comprises the comment material.

In one embodiment of the present disclosure, when the sending unit 802 is configured to: in response to a request instruction for sending comment data, if the comment data has been confirmed, present the comment data in a playing process of the target video, the sending unit is configured to:
in response to the request instruction for sending the comment data, send the comment data to a terminal of a target video poster, so that the video poster confirms the comment data; and
if the comment data has been confirmed, present the comment data in the playing process of the target video.

In one embodiment of the present disclosure, the comment data comprises attribute information of the comment material, and the video processing apparatus further includes an editing unit 803, configured to:
display an editing interface for the comment material after acquiring the comment material; and
in response to a setting instruction for the comment material in the editing interface, set the attribute information of the comment material in the target video according to the setting instruction.

In one embodiment of the present disclosure, when setting the attribute information of the comment material in the target video according to the setting instruction, the editing unit 803 is configured to:
set at least one of a style, position, time information, and motion trajectory of the comment material in the target video according to the setting instruction.

In one embodiment of the present disclosure, when setting the style and/or position of the comment material in the target video according to the setting instruction, the editing unit 803 is configured to:
display a video picture of the target video at a target moment in the editing interface, and add a canvas on the video picture, wherein the canvas is used for displaying the comment material; and
in response to a setting instruction for a style and/or position of the canvas, determine the style and/or position of the comment material displayed on the canvas.

In one embodiment of the present disclosure, when setting the time information of the comment material in the target video according to the setting instruction, the editing unit 803 is configured to:
display a video track of the target video and a comment track of the comment material in the editing interface;
in response to a dragging instruction for the comment track of the comment material, determine a start point and an end point of the comment track of the comment material; and
determine the time information of the comment material in the target video according to a correspondence relationship between the video track of the target video and the comment track of the comment material.

In one embodiment of the present disclosure, when setting the motion trajectory of the comment material in the target video according to the setting instruction, the editing unit 803 is configured to:
display a video picture of the target video at a target moment in the editing interface, and add a canvas on the video picture, wherein the canvas is used for displaying the comment material; a video track or a progress bar of the target video is displayed in the editing interface; and
in response to a setting instruction for a motion trajectory on the canvas, determine canvas positions corresponding to different time points in the video track or the progress bar to determine the motion trajectory of the comment material.

In one embodiment of the present disclosure, when determining the time information of the comment material in the target video according to a correspondence relationship between the video track of the target video and the comment track of the comment material, the editing unit 803 is configured to:

according to the correspondence relationship between the video track of the target video and the comment track of the comment material, establish a mapping relationship between each frame of picture of the comment material and a timeline of the target video, or establish a mapping relationship between each frame of picture of the comment material and a video frame of the target video, or establish a mapping relationship between a timeline of the comment material and a timeline of the target video.

In one embodiment of the present disclosure, the video processing apparatus further includes a receiving unit, configured to:

receive notification information sent by the terminal of the target video poster after the target video poster has confirmed the comment data, and display the notification information.

In one embodiment of the present disclosure, the video processing apparatus further includes a display unit, and when presenting the comment data in the playing process of the target video, the display unit is specifically configured to:

display the comment material in a masked manner in a video picture of the target video according to the comment data.

The video processing apparatus provided by this embodiment can be configured to perform the technical solutions of the method embodiment of the terminal side of the comment sender, and an implementation principle and technical effects thereof are similar to those of the method embodiment, so that the apparatus will not be described in detail here in this embodiment.

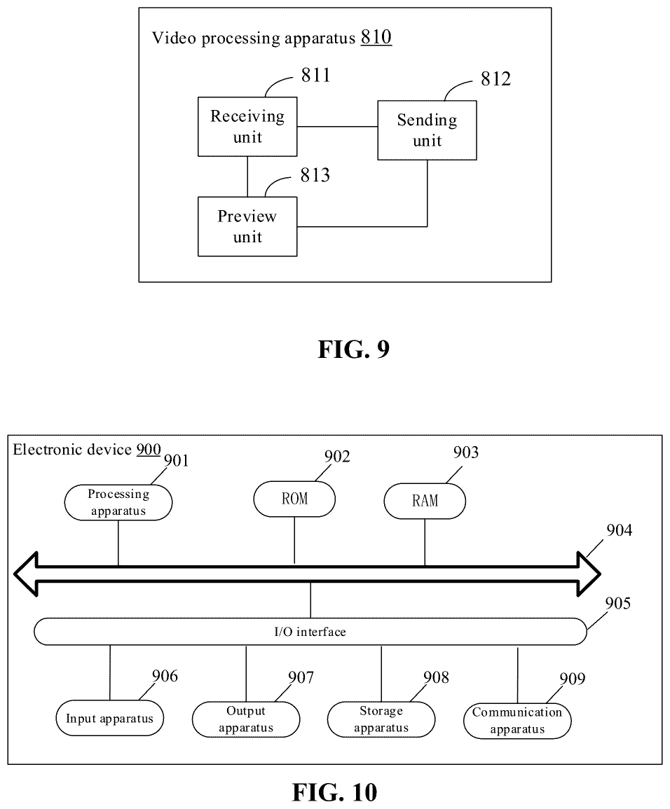

Corresponding to the video processing method of the terminal side of the target video poster in the above embodiment, FIG. 9 is a structural block diagram of a video processing apparatus according to an embodiment of the present disclosure. For ease of explanation, only parts related to the embodiments of the present disclosure are shown. Referring to FIG. 9, the video processing apparatus 810 includes a receiving unit 811 and a sending unit 812.

The receiving unit 811 is configured to: receive comment data sent by a terminal of a comment sender, wherein the comment data comprises a comment material and attribute information thereof, and the comment material includes an image; and

the sending unit 812 is configured to: in response to a confirming instruction for the comment data, add the comment data into the target video.

The video processing apparatus 810 further includes: a preview unit 813, configured to: in response to a comment preview instruction, display a preview interface, display the comment material in the target video in the preview interface according to the comment data, and display presentation time information of the comment material on a progress bar corresponding to the target video. The present disclosure enriches the function of the progress bar. In a scenario where the video poster confirms a comment, the presentation time information of the comment material is displayed on the progress bar of the preview interface, which facilitates the video poster to quickly understand comment attribute information and is beneficial for the video poster to acquire an overall association relationship between the comment and the video, thereby confirming the comment.

In one embodiment of the present disclosure, the preview unit 813 is further configured to:

if comment data sent by terminals of a plurality of different comment senders has been received, screen and/or sequence and present the comment data according to a predetermined policy.

In one embodiment of the present disclosure, the sending unit 812 is further configured to add the comment data into the target video according to an association degree between the comment material and the target video.

In one embodiment of the present disclosure, the preview unit 813 is further configured to:
in response to a comment data modification instruction, modify attribute information of the comment material in the comment data; or
send a modification request performed on the comment material and/or the attribute information of the comment material to the terminal of the comment sender, so that the comment sender modifies the comment data according to the modification request.

In one embodiment of the present disclosure, the sending unit 812 is further configured to:
in response to the confirming instruction for the comment data, send notification information that indicates a confirmation success the terminal of the comment sender; or
in response to a confirmation failure instruction, send notification information that indicates a confirmation failure to the terminal of the comment sender.

The video processing apparatus provided by this embodiment can be configured to perform the technical solutions of the method embodiment of the terminal side of the target video poster, and an implementation principle and technical effects thereof are similar to those of the method embodiment, so that the apparatus will not be described in detail here in this embodiment.

Further, referring to FIG. 10, a schematic structural diagram of an electronic device 900 suitable for implementing the embodiments of the present disclosure is shown. The electronic device 900 can be a terminal device or a server. The terminal device can include but is not limited to mobile terminals such as a mobile phone, a laptop, a digital broadcast receiver, a Personal Digital Assistant (PDA), a Portable Android Device (PAD), a Portable Media Player (PMP), a vehicle-mounted terminal (such as a vehicle-mounted navigation terminal), and fixed terminals such as a digital TV and a desk computer. The electronic device shown in FIG. 10 is only an example and should not impose any limitations on the functionality and scope of use of the embodiments of the present disclosure.

As shown in FIG. 10, the electronic device 900 may include a processing apparatus (such as a central processing unit and graphics processor) 901 that can perform various appropriate actions and processing according to programs stored in a Read Only Memory (ROM) 902 or loaded from a storage apparatus 908 to a Random Access Memory (RAM) 903. Various programs and data required for operations of the electronic device 900 may also be stored in the RAM 903. The processing apparatus 901, the ROM 902, and the RAM 903 are connected to each other through a bus 904. An Input/Output (I/O) interface 905 is also connected to the bus 904.

Usually, following apparatuses can be connected to the I/O interface 905: an input apparatus 906 including a touch screen, a touchpad, a keyboard, a mouse, a camera, a microphone, an accelerometer, a gyroscope, and the like; an output apparatus 907 including a Liquid Crystal Display (LCD), a speaker, a vibrator, and the like; a storage apparatus 908 including a magnetic tape, a hard disk drive, and the like; and a communication apparatus 909. The communication apparatus 909 can allow the electronic device 900 to wirelessly or wiredly communicate with other devices to exchange data. Although FIG. 10 shows the electronic device 900 with multiple apparatuses, it should be understood that the electronic device 900 is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present disclosure include a computer program product, including a computer program carried on a computer-readable medium, and the computer program includes program codes used for performing the methods shown in the flowcharts. In such an embodiment, the computer program may be downloaded and installed from a network through the communication apparatus 909, or installed from the storage apparatus 908, or installed from the ROM 902. When the computer program is executed by the processing apparatus 901, the above-mentioned functions defined in the method of the terminal side of the comment sender in the embodiments of the present disclosure or in the method of the terminal side of the target video poster.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage media may include, but are not limited to: an electrical connection with one or more wires, a portable computer disk, a hard disk drive, a RAM, a ROM, an Erasable Programmable Read Only Memory (EPROM or flash memory), an optical fiber, Compact Disk Read Only Memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but not limited to: a wire, an optical cable, a Radio Frequency (RF), and the like, or any suitable combination of the above.

The computer-readable medium may be included in the electronic device or exist alone and is not assembled into the electronic device.

The above computer-readable medium carries one or more programs. When executed by the electronic device, the one or more programs cause the electronic device to implement the methods shown in the above embodiments.

Computer program codes for performing the operations of the present disclosure may be written in one or more programming languages or a combination thereof. The above programming languages include an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. If a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure can be implemented through software or hardware. The name of the unit does not constitute a limitation on the unit itself. For example, the first obtaining unit can also be described as “a unit that obtains at least two Internet protocol addresses”.

The functions described herein above may be performed, at least in part, by one or a plurality of hardware logic components. For example, nonrestrictively, exemplary hardware logic components that can be used include: a Field Programmable Gate Array (FPGA), an Application Specific Integrated Circuit (ASIC), an Application Specific Standard Product (ASSP), a System On Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

In a first aspect, according to one or more embodiments of the present disclosure, a video processing method is provided, applied to a terminal of a comment sender. The method includes:
in response to a comment data input instruction for a target video, acquiring a comment material, wherein the comment material includes an image; and
in response to a request instruction for sending comment data, if the comment data has been confirmed, presenting the comment data in a playing process of the target video, wherein the comment data comprises the comment material.

According to one or more embodiments of the present disclosure, the in response to a request instruction for sending comment data, if the comment data has been confirmed, presenting the comment data in a playing process of the target video includes:
in response to the request instruction for sending the comment data, sending the comment data to a terminal of a target video poster, so that the video poster confirms the comment data; and
if the comment data has been confirmed, presenting the comment data in the playing process of the target video.

According to one or more embodiments of the present disclosure, the comment data further includes attribute information of the comment material; and after the acquiring a comment material, the method further includes:
displaying an editing interface for the comment material; and
in response to a setting instruction for the comment material in the editing interface, setting the attribute information of the comment material in the target video according to the setting instruction.

According to one or more embodiments of the present disclosure, the setting the attribute information of the comment material in the target video according to the setting instruction includes:
setting at least one of a style, position, time information, and motion trajectory of the comment material in the target video according to the setting instruction.

According to one or more embodiments of the present disclosure, the style and/or position of the comment material is set in the target video according to the setting instruction, which includes:
displaying a video picture of the target video at a target moment in the editing interface, and adding a canvas on the video picture, wherein the canvas is used for displaying the comment material; and
in response to a setting instruction for a style and/or position of the canvas, determining the style and/or position of the comment material displayed on the canvas.

According to one or more embodiments of the present disclosure, the time information of the comment material is set in the target video according to the setting instruction, which includes:
displaying a video track of the target video and a comment track of the comment material in the editing interface;
in response to a dragging instruction for the comment track of the comment material, determining a start point and an end point of the comment track of the comment material; and
determining the time information of the comment material in the target video according to a correspondence relationship between the video track of the target video and the comment track of the comment material.

According to one or more embodiments of the present disclosure, the motion trajectory of the comment material is set in the target video according to the setting instruction, which includes:
displaying a video picture of the target video at a target moment in the editing interface, and adding a canvas on the video picture, wherein the canvas is used for displaying the comment material; a video track or a progress bar of the target video is displayed in the editing interface; and
in response to a setting instruction for a motion trajectory on the canvas, determining canvas positions corresponding to different time points in the video track or the progress bar to determine the motion trajectory of the comment material.

According to one or more embodiments of the present disclosure, the determining the time information of the comment material in the target video according to a correspondence relationship between the video track of the target video and the comment track of the comment material includes:
according to the correspondence relationship between the video track of the target video and the comment track of the comment material, establishing a mapping relationship between each frame of picture of the comment material and a timeline of the target video, or establishing a mapping relationship between each frame of picture of the comment material and a video frame of the target video, or establishing a mapping relationship between a timeline of the comment material and a timeline of the target video.

According to one or more embodiments of the present disclosure, the method further includes:
receiving notification information sent by the terminal of the target video poster after the target video poster has confirmed the comment data, and displaying the notification information.

According to one or more embodiments of the present disclosure, the presenting the comment data in a playing process of the target video includes:
displaying the comment material in a masked manner in a video picture of the target video according to the comment data.

In a second aspect, according to one or more embodiments of the present disclosure, a video processing method is provided, applied to a terminal of a target video poster. The method includes:
receiving comment data sent by a terminal of a comment sender, wherein the comment data comprises a comment material and attribute information thereof, and the comment material includes an image; and
in response to a confirming instruction for the comment data, adding the comment data into the target video.

According to one or more embodiments of the present disclosure, the comment data also includes attribute information of the comment material, and the attribute information includes at least one of a style, position, time information, and motion trajectory of the comment material. The method further includes:
in response to a comment preview instruction, displaying a preview interface, displaying the comment material in the target video in the preview interface according to the comment data, and displaying presentation time information of the comment material on a progress bar corresponding to the target video.

According to one or more embodiments of the present disclosure, the method further includes:

if comment data sent by terminals of a plurality of different comment senders has been received, screening and/or sequencing and presenting the comment data according to a predetermined policy.

According to one or more embodiments of the present disclosure, the method further includes:

adding the comment data into the target video according to an association degree between the comment material and the target video.

According to one or more embodiments of the present disclosure, the method further includes:
in response to a comment data modification instruction, modifying attribute information of the comment material in the comment data; or
sending a modification request performed on the comment material and/or the attribute information of the comment material to the terminal of the comment sender, so that the comment sender modifies the comment data according to the modification request.

According to one or more embodiments of the present disclosure, the method further includes:
in response to the confirming instruction for the comment data, send notification information that indicates a confirmation success the terminal of the comment sender; or
in response to a confirmation failure instruction, sending notification information that indicates a confirmation failure to the terminal of the comment sender.

In a third aspect, according to one or more embodiments of the present disclosure, a video processing apparatus is provided, applied to a terminal of a comment sender. The apparatus includes:
an inputting unit, configured to: in response to a comment data input instruction for a target video, acquire a comment material, wherein the comment material includes an image; and
a sending unit, configured to: in response to a request instruction for sending comment data, if the comment data has been confirmed, present the comment data in a playing process of the target video, wherein the comment data comprises the comment material.

According to one or more embodiments of the present disclosure, when the sending unit is configured to: in response to a request instruction for sending comment data, if the comment data has been confirmed, present the comment data in a playing process of the target video, the sending unit is configured to:
in response to the request instruction for sending the comment data, send the comment data to a terminal of a target video poster, so that the video poster confirms the comment data; and
if the comment data has been confirmed, present the comment data in the playing process of the target video.

According to one or more embodiments of the present disclosure, the comment data comprises attribute information of the comment material, and the video processing apparatus further includes an editing unit, configured to:
display an editing interface for the comment material after acquiring the comment material; and
in response to a setting instruction for the comment material in the editing interface, set the attribute information of the comment material in the target video according to the setting instruction.

According to one or more embodiments of the present disclosure, when setting the attribute information of the comment material in the target video according to the setting instruction, the editing unit is configured to:

set at least one of a style, position, time information, and motion trajectory of the comment material in the target video according to the setting instruction.

According to one or more embodiments of the present disclosure, when setting the style and/or position of the comment material in the target video according to the setting instruction, the editing unit is configured to:
display a video picture of the target video at a target moment in the editing interface, and add a canvas on the video picture, wherein the canvas is used for displaying the comment material; and
in response to a setting instruction for a style and/or position of the canvas, determine the style and/or position of the comment material displayed on the canvas.

According to one or more embodiments of the present disclosure, when setting the time information of the comment material in the target video according to the setting instruction, the editing unit is configured to:
display a video track of the target video and a comment track of the comment material in the editing interface;
in response to a dragging instruction for the comment track of the comment material, determine a start point and an end point of the comment track of the comment material; and
determine the time information of the comment material in the target video according to a correspondence relationship between the video track of the target video and the comment track of the comment material.

According to one or more embodiments of the present disclosure, when setting the motion trajectory of the comment material in the target video according to the setting instruction, the editing unit is configured to:
display a video picture of the target video at a target moment in the editing interface, and add a canvas on the video picture, wherein the canvas is used for displaying the comment material; a video track or a progress bar of the target video is displayed in the editing interface; and
in response to a setting instruction for a motion trajectory on the canvas, determine canvas positions corresponding to different time points in the video track or the progress bar to determine the motion trajectory of the comment material.

According to one or more embodiments of the present disclosure, when determining the time information of the comment material in the target video according to a correspondence relationship between the video track of the target video and the comment track of the comment material, the editing unit is configured to:

according to the correspondence relationship between the video track of the target video and the comment track of the comment material, establish a mapping relationship between each frame of picture of the comment material and a timeline of the target video, or establish a mapping relationship between each frame of picture of the comment material and a video frame of the target video, or establish a mapping relationship between a timeline of the comment material and a timeline of the target video.

According to one or more embodiments of the present disclosure, the video processing apparatus further includes a receiving unit, configured to:

receive notification information sent by the terminal of the target video poster after the target video poster has confirmed the comment data, and display the notification information.

According to one or more embodiments of the present disclosure, the video processing apparatus further includes a display unit, and when presenting the comment data in the playing process of the target video, the display unit is specifically configured to:
display the comment material in a masked manner in a video picture of the target video according to the comment data.

In a fourth aspect, according to one or more embodiments of the present disclosure, a video processing apparatus is provided, applied to a terminal of a target video poster. The apparatus includes:
a receiving unit, configured to: receive comment data sent by a terminal of a comment sender, wherein the comment data comprises a comment material and attribute information thereof, and the comment material includes an image; and
a sending unit, configured to: in response to a confirming instruction for the comment data, add the comment data into the target video.

According to one or more embodiments of the present disclosure, the comment data also includes attribute information of the comment material, and the attribute information includes at least one of a style, position, time information, and motion trajectory of the comment material. The apparatus further includes:

a preview unit, configured to: in response to a comment preview instruction, display a preview interface, display the comment material in the target video in the preview interface according to the comment data, and display presentation time information of the comment material on a progress bar corresponding to the target video.

According to one or more embodiments of the present disclosure, the preview unit is further configured to:
if comment data sent by terminals of a plurality of different comment senders has been received, screen and/or sequence and present the comment data according to a predetermined policy.

According to one or more embodiments of the present disclosure, the sending unit is further configured to:
add the comment data into the target video according to an association degree between the comment material and the target video.

According to one or more embodiments of the present disclosure, the preview unit is further configured to:
in response to a comment data modification instruction, modify attribute information of the comment material in the comment data; or
send a modification request performed on the comment material and/or the attribute information of the comment material to the terminal of the comment sender, so that the comment sender modifies the comment data according to the modification request.

According to one or more embodiments of the present disclosure, the sending unit is further configured to:
in response to the confirming instruction for the comment data, send notification information that indicates a confirmation success the terminal of the comment sender; or
in response to a confirmation failure instruction, send notification information that indicates a confirmation failure to the terminal of the comment sender.

In a fifth aspect, according to one or more embodiments of the present disclosure, an electronic device is provided, including: at least one processor and a memory,
wherein the memory stores computer-executable instructions; and
the at least one processor executes the computer-executable instructions stored in the memory to cause the at least one processor to perform the video processing method designed in the first aspect and various possible video processing methods in the first aspect or the video processing method designed in the second aspect and various possible video processing methods in the second aspect.

In a sixth aspect, according to one or more embodiments of the present disclosure, a computer-readable storage medium is provided, wherein the computer-readable storage medium stores computer-executable instructions; and a processor, when executing the computer-executable instructions, implements the video processing method designed in the first aspect and various possible video processing methods in the first aspect, or the video processing method designed in the second aspect and various possible video processing methods in the second aspect.

In a seventh aspect, according to one or more embodiments of the present disclosure, a computer program product is provided, including computer-executable instructions, wherein a processor, when executing the computer-executable instructions, implements the video processing method designed in the first aspect and various possible video processing methods in the first aspect, or the video processing method designed in the second aspect and various possible video processing methods in the second aspect.

In an eighth aspect, according to one or more embodiments of the present disclosure, a computer program is provided, wherein the computer program, when executed by a processor, implements the video processing method designed in the first aspect and various possible video processing methods in the first aspect, or the video processing method designed in the second aspect and various possible video processing methods in the second aspect.

According to the video processing methods, the device, the storage medium, and the program product, in response to a comment data input instruction for a target video, a terminal of a comment sender acquires a comment material, wherein the comment material includes an image; and in response to a request instruction for sending comment data, if the comment data has been confirmed, the comment data is presented in a playing process of the target video, wherein the comment data comprises the comment material. The embodiments of the present disclosure enrich the comment interaction manner and improves the user experience.

The above description is only for explaining the preferred embodiments of the present disclosure and technical principles used in the embodiments. Those skilled in the art should understand that the scope of disclosure referred to in the present disclosure is not limited to the technical solutions formed by specific combinations of the aforementioned technical features, but also covers other technical solutions formed by any combinations of the aforementioned technical features or their equivalent features without departing from the concept of the above disclosure, For example, a technical solution formed by replacing the above features with (but not limited to) technical features with similar functions disclosed in the present disclosure.

In addition, although various operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. On the contrary, the specific features and actions described above are only exemplary forms for implementing the claims.

1. A video processing method, applied to a terminal of a comment sender, wherein the method comprises:
in response to a comment data input instruction for a target video, acquiring a comment material, wherein the comment material comprises an image; and
in response to a request instruction for sending comment data, if the comment data has been confirmed, presenting the comment data during a playing process of the target video, wherein the comment data comprises the comment material.

2. The method according to claim 1, wherein the in response to a request instruction for sending comment data, if the comment data has been confirmed, presenting the comment data in a playing process of the target video comprises:
in response to the request instruction for sending the comment data, sending the comment data to a terminal of a target video poster, so that the target video poster confirms the comment data; and
if the comment data has been confirmed, presenting the comment data in the playing process of the target video.

3. The method according to claim 1, wherein the comment data further comprises attribute information of the comment material; and after the acquiring a comment material, the method further comprises:
displaying an editing interface for the comment material; and
in response to a setting instruction for the comment material in the editing interface, setting the attribute information of the comment material in the target video according to the setting instruction.

4. The method according to claim 3, wherein setting the attribute information of the comment material in the target video according to the setting instruction comprises:
setting at least one of a style, position, time information, and motion trajectory of the comment material in the target video according to the setting instruction.

5. The method according to claim 4, wherein setting the style and/or position of the comment material in the target video according to the setting instruction, comprises:
displaying a video picture of the target video at a target moment in the editing interface, and adding a canvas on the video picture, wherein the canvas is used for displaying the comment material; and
in response to a setting instruction for a style and/or position of the canvas, determining the style and/or position of the comment material displayed on the canvas.

6. The method according to claim 4, wherein setting the time information of the comment material in the target video according to the setting instruction, comprises:
displaying a video track of the target video and a comment track of the comment material in the editing interface;
in response to a dragging instruction for the comment track of the comment material, determining a start point and an end point of the comment track of the comment material; and
determining the time information of the comment material in the target video according to a correspondence relationship between the video track of the target video and the comment track of the comment material.

7. The method according to claim 4, wherein setting the motion trajectory of the comment material in the target video according to the setting instruction, comprises:
displaying a video picture of the target video at a target moment in the editing interface, and adding a canvas on the video picture, wherein the canvas is used for displaying the comment material; displaying a video track or a progress bar of the target video in the editing interface; and
in response to a setting instruction for a motion trajectory on the canvas, determining canvas positions corresponding to different time points in the video track or the progress bar to determine the motion trajectory of the comment material.

8. The method according to claim 6, wherein determining the time information of the comment material in the target video according to a correspondence relationship between the video track of the target video and the comment track of the comment material comprises:
according to the correspondence relationship between the video track of the target video and the comment track of the comment material, establishing a mapping relationship between each frame of picture of the comment material and a timeline of the target video, or establishing a mapping relationship between each frame of picture of the comment material and a video frame of the target video, or establishing a mapping relationship between a timeline of the comment material and a timeline of the target video.

9. The method according to claim 2, wherein the method further comprises:
receiving notification information sent by the terminal of the target video poster after the target video poster has confirmed the comment data, and displaying the notification information.

10. The method according to claim 1, wherein the image comprises at least one of a static picture, a dynamic picture, or a video clip.

11. A video processing method, applied to a terminal of a target video poster, wherein the method comprises:
receiving comment data sent by a terminal of a comment sender, wherein the comment data comprises a comment material, and the comment material comprises an image; and
in response to a confirming instruction for the comment data, adding the comment data into the target video.

12. The method according to claim 11, wherein the method further comprises:
in response to a comment preview instruction, displaying a preview interface, displaying the comment material in the target video in the preview interface according to the comment data, and displaying presentation time information of the comment material on a progress bar corresponding to the target video.

13. The method according to claim 11, wherein the method further comprises:
if comment data sent by terminals of a plurality of different comment senders has been received, screening and/or sequencing and presenting the comment data according to a predetermined policy.

14. The method according to claim 13, wherein the method further comprises:
adding the comment data into the target video according to an association degree between the comment material and the target video.

15. The method according to claim 11, wherein the method further comprises:
in response to a comment data modification instruction, modifying attribute information of the comment material in the comment data; or
sending a modification request performed on the comment material and/or the attribute information of the comment material to the terminal of the comment sender, so that the comment sender modifies the comment data according to the modification request.

16. The method according to claim 11, wherein the image comprises at least one of a static picture, a dynamic picture, or a video clip.

17. An electronic device, comprising: at least one processor, a memory, and a display unit, wherein the memory stores computer-executable instructions; and
the at least one processor executes the computer-executable instructions stored in the memory to cause the at least one processor to:
in response to a comment data input instruction for a target video, acquire a comment material, wherein the comment material comprises an image; and
in response to a request instruction for sending comment data, if the comment data has been confirmed, present the comment data based the comment material during a playing process of the target video.

18. The electronic device according to claim 17, wherein the image comprises at least one of a static picture, a dynamic picture, or a video clip.

19. The electronic device according to claim 17, wherein the computer-executable instructions to cause the at least one processor to: in response to a request instruction for sending comment data, if the comment data has been confirmed, present the comment data in a playing process of the target video, comprise the computer-executable instructions to cause the at least one processor to:
in response to the request instruction for sending the comment data, sending the comment data to a terminal of a target video poster, so that the target video poster confirms the comment data; and
if the comment data has been confirmed, presenting the comment data in the playing process of the target video.

20. The electronic device according to claim 17, wherein the comment data further comprises attribute information of the comment material; and after the processor is caused to acquire a comment material, the computer-executable instructions further comprise computer-executable instructions to cause the at least one processor to:
display an editing interface for the comment material; and
in response to a setting instruction for the comment material in the editing interface, set the attribute information of the comment material in the target video according to the setting instruction.
